(19) United States
(12) Patent Application Publication
(10) Pub. No.: US 2003/0059164 A1
(43) Pub. Date: Mar. 27, 2003

(54) Grating error compensating technique

(76) Inventors: Dimitrii Stepanov, New South Wales (AU); Alexander Buryak, New South Wales (AU)

Correspondence Address: PILLSBURY WINTHROP, LLP, P.O. BOX 10500, MCLEAN, VA, 22102, US

(21) Appl. No.: 09/961,378

(22) Filed: Sep. 25, 2001

(51) Int. Cl. G02B 6/34; G02B 27/44

(52) U.S. Cl. 385/37; 359/566

(57) ABSTRACT

A method of reducing systematic errors in grating writing in an optical waveguide, the method comprising the steps of a) numerically designing a theoretical test grating structure for desired spectral characteristics, b) writing a test grating structure experimentally and according to the theoretical test grating structure design, c) measuring the actual spectral characteristics of the test grating structure, d) reconstructing an actual design of the test grating structure from the actual spectral characteristics, and e) writing a compensated grating structure using a compensated design based on a comparison of the initial numerical design with the actual design of the test grating.

### FIELD OF THE INVENTION

The present invention relates broadly to a method of reducing systematic errors in grating writing in an optical waveguide, to a method for writing a grating structure, to an arrangement for grating writing, and to a waveguide structure incorporating a grating structure.

### BACKGROUND OF THE INVENTION

In photonics technology, grating structures are widely used for various applications such as for filtering optical signals, redirecting portions of optical signals etc. As such, grating structures are incorporated in many optical devices, including e.g. in wavelength division multiplexing (WDM) multiplexers, or sensors.

Grating structures are typically written into photosensitive waveguides utilising photo-induced refractive index changes. In one grating writing technique, two coherent beams are brought into interference substantially within the waveguide, whereby an interference pattern is created within the waveguide, which in turn is utilised to induce the refractive index changes for forming the grating structure in the waveguide.

More recently, methods for writing long grating structures into e.g. optical fibres have been developed, in which an effect some times referred to as “running-light” effect is used to write long grating structures while relative movement between the waveguide and the two interfering beams occurs. Essentially, movement of the interference pattern in the intersection between the two coherent beams is synchronised with the relative movement between the waveguide and the intersection, the movement of the interference pattern being affected through inducing relative frequency or phase differences between the two coherent beams.

It has been found that in such writing methods there may exist a significant systematic experimental deviation from a desired grating characteristics. While the causes for such deviations are not fully understood at this stage, it is believed that non uniform relative motion between the waveguide and the interferometer may contribute significantly to such deviations, e.g. non-uniform translation stage motion where the waveguide is moved along the interferometer utilising a linear translation stage.

In at least preferred embodiments, the present invention seeks to provide a method of reducing systematic errors in grating writing in an optical waveguide.

### SUMMARY OF THE INVENTION

In accordance with a first aspect of the present invention there is provided a method of reducing systematic errors in grating writing in an optical waveguide, the method comprising the steps of a) numerically designing a theoretical test grating structure for desired spectral characteristics, b) writing a test grating structure experimentally and according to the theoretical test grating structure design, c) measuring the actual spectral characteristics of the test grating structure, d) reconstructing an actual design of the test grating structure from the actual spectral characteristics, and e) writing a compensated grating structure using a compensated design based on a comparison of the initial numerical design with the actual design of the test grating.

The step of reconstructing the actual design may comprise solving an inverse scattering problem based on the measured actual spectral characteristics. The solving of the inverse scattering problem may comprise utilising a layer-peeling algorithm.

The compensated grating structure may be based on a different theoretical grating structure than the theoretical test grating structure, whereby compensation information gained from steps a) to d) can be used repeatedly for the writing of different grating structures.

Preferably, the comparison of the actual with the initial numerical design comprises subtracting deviations of the actual from the numerical design from the numerical design to form the compensated design. Preferably, the deviations are filtered from high frequency components.

Alternatively, the comparison of the actual with the initial numerical design comprises multiplying the theoretical test grating function with a ratio of the theoretical test grating function and the actual test grating function.

The step of measuring the actual spectral characteristics may comprise measuring the actual spectral characteristics of the test grating from both ends thereof.

The step of reconstructing the actual design may comprise utilising different weighting factors for the different end reconstructions of the test grating to form the reconstructed actual design.

Alternatively, the step of reconstructing the actual design may comprise substantially a half-sum of different end reconstructions of the test grating.

Steps c) to e) may be repeated, wherein the compensated design structure takes on the role of the test grating structure. The steps c) to e) may be repeated until a desired accuracy is achieved or no further improvement in the accuracy is found.

Preferably, the steps of writing the test grating and the compensated grating comprise utilising an interferometer for inducing refractive index changes in the waveguide to form the test and the compensated grating structures.

The waveguide may be in the form of an optical fiber or a planar waveguide.

In accordance with a second aspect of the present invention, there is provided a method for writing a grating structure in an optical waveguide, the method comprising the step of utilising compensation information gained from conducting the steps of a) numerically designing a theoretical grating test structure for desired spectral characteristics, b) writing a test grating structure experimentally and according to the theoretical test grating structure design, c) measuring the actual spectral characteristics of the test grating structure, d) reconstructing an actual design of the test grating structure from the actual spectral characteristics.

The compensation information may be provided in the form of stored compensation data previously obtained for a particular grating writing arrangement.

In accordance with a third aspect of the present invention, there is provided an arrangement for grating writing in an optical waveguide, the arrangement comprising a processing means arranged, in use, to control the writing of a grating structure based on a theoretical grating design and compensation data obtained for the arrangement to compensate for systematic errors.

Preferably, the compensation data is of a type obtained from conducting the steps of a) numerically designing a theoretical grating test structure for desired spectral characteristics, b) writing a test grating structure experimentally and according to the theoretical test grating structure design, c) measuring the actual spectral characteristics of the test grating structure, d) reconstructing an actual design of the test grating structure from the actual spectral characteristics.

In accordance with a fourth aspect, there is provided a waveguide structure incorporating a grating written utilising the methods of the first aspect or second aspect.

### BRIEF DESCRIPTION OF THE DRAWINGS

Preferred embodiments of the present invention will now be described, by way of example only, with reference to the accompanying drawings.

FIG. 1 is a schematic diagram illustrating an interferometer for writing gratings into an optical waveguide.

FIGS. 2A to F are schematic drawings illustrating a method of reducing systematic errors in grating writing in an optical waveguide, embodying the present invention.

### DETAILED DESCRIPTION OF THE EMBODIMENTS

The preferred embodiments described provide a method of reducing systematic errors in grating writing in an optical waveguide, utilising an open loop grating error compensation technique.

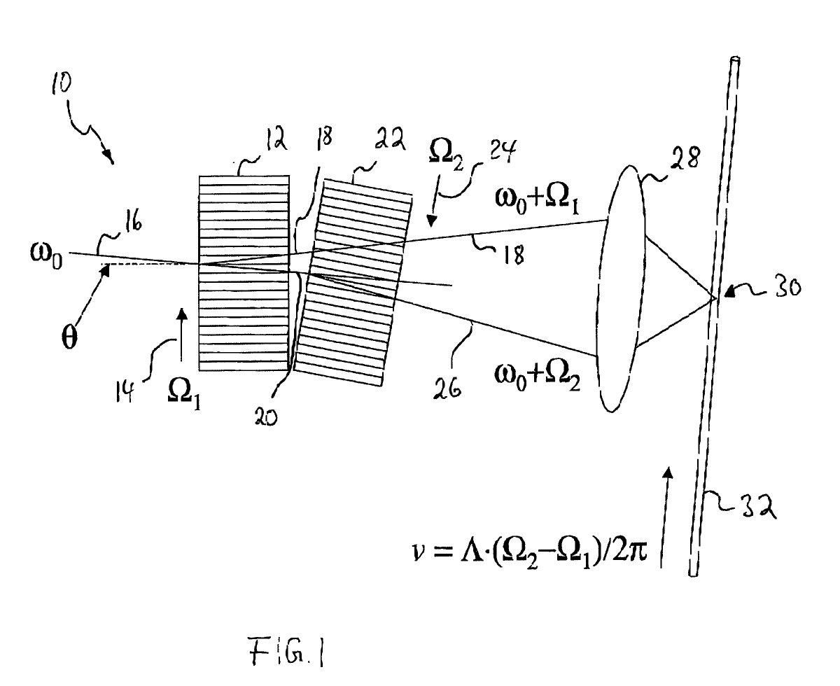

In FIG. 1, an interferometer 10 for writing long grating structures comprises a first acousto-optic modulator 12 being operated under an acousto-optic wave of a first frequency Ω₁, as indicated by arrow 14. An incoming light beam 16 is incident on the acousto-optic modulator 12 under a first order Bragg angle. The operating conditions of the acousto-optic modulator 12 are chosen such that the modulator 12 is under-driven, whereby approximately 50% of the incoming beam 16 is diffracted into a first order beam 18, and 50% passes through the acousto-optic modulator 12 an un-diffracted beam 20. The un-diffracted beam 20 in incident on a second acousto-optic modulator 22 of the interferometer 10 under a first order Bragg angle, whereas the beam 18 is not. Accordingly, the beam 18 passes through the second acousto optic modulator 22 without any significant loss.

The second acousto-optic modulator 22 is operated under an acousto-optic wave of a frequency Ω₂, which propagates in a direction opposed to the direction of the acousto-optic wave in the first modulator 12, as indicated by arrow 24. After the second acousto-optic modulator the first order diffracted beam 26 and the beam 18 are frequency shifted in the same direction (e.g. higher frequency), but by different amounts, ie Ω₁ versus Ω₂.

The beams 18, 26 are then brought to interference utilising an optical lens 28, and the resultant interference (at numeral 30) induces refractive index changes in a photosensitive optical fibre 32, whereby a refractive index profile, ie grating structure, is created in the optical fibre 32.

In the set-up illustrated in FIG. 1, the optical fibre 32 is translated along the interferometer 10 at a speed chosen such that a long grating structure can be written, utilising a moving interference pattern which is being created as a result of the modulation of beams 18, 26. The speed of translation of the optical fibre 32 is matched to the “speed” of the interference pattern change, whereby a continuous grating structure can be written into optical fiber 32. This technique is sometimes referred to as the “running light” effect.

The velocity of the interference pattern change is given by:

v=Λ (Ω₂−Ω₁/2π,

when Λ is the period of the interference pattern, which in turn depends inter alia on the angle between the interfering beams 18, 26 at numeral 30.

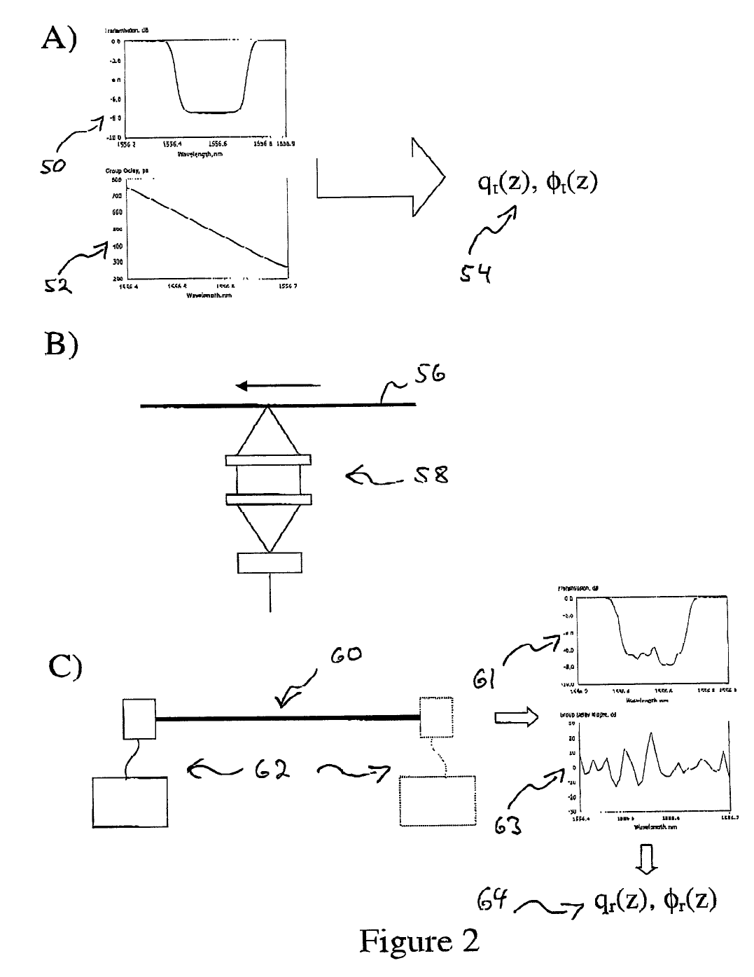

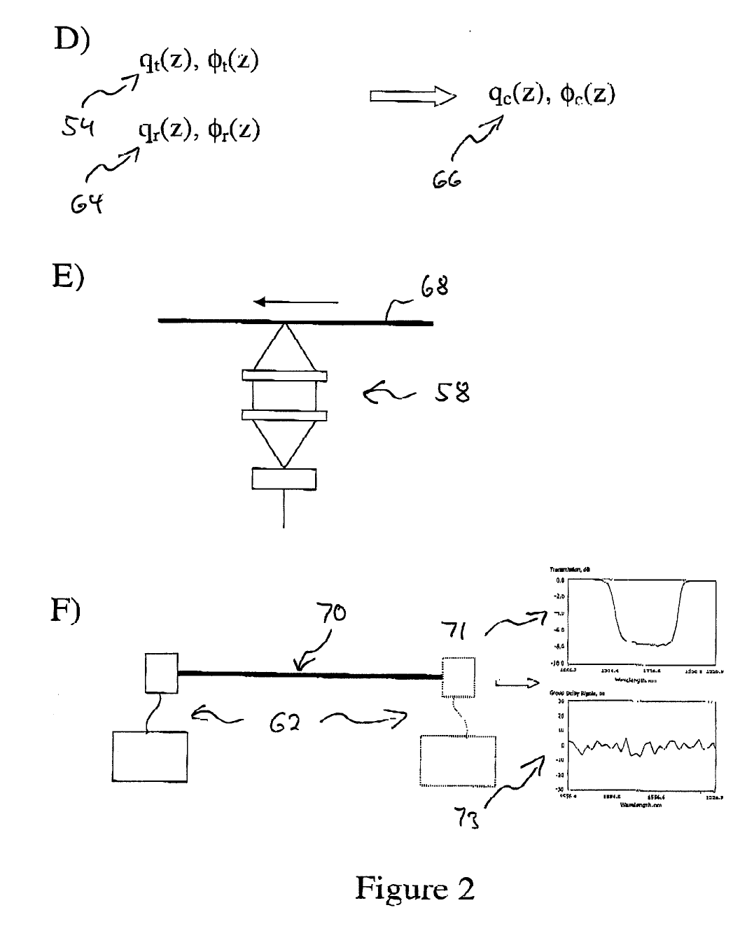

In FIGS. 2A to F, a method of reducing the systematic arrow in grating writing embodying the present invention is illustrated, and will now be described.

Turning initially to FIG. 2A, a desired transmission characteristic 50 and a desired group delay characteristic 52 form the basis for designing numerically a theoretical design function, which may be defined as [q₁(z) amplitude, φ₁(z)-phase] at numeral 54. The numerically designing in the exemplary embodiment involves solving an inverse scattering problem based on the desired reflection characteristic 50 and the desired group delay characteristic 52.

Subsequently, illustrated in FIG. 2B, a grating is written into an optical fibre 56 based on the theoretical design function at numeral 54, utilising an interferometer 58, e.g. an interferometer similar to the one described above with reference to FIG. 1.

After the writing of the test grating 60, the experimental transmission characteristics 61 and group delay characteristics (group delay ripple shown at numeral 63) of the written test grating 60 are measured, as illustrated in FIG. 2C. The reflection and group delay characteristics of the actual test grating 60 are measured from both ends, utilising a known grating characteristics measurement device 62. For both end measurements, the actual grating design of the test grating 60 is reconstructed by solving an inverse scattering problem utilising a so-called layer-peeling algorithm. Ideally, the two reconstructions (obtained from the two end measurements) should coincide, however experimentally they do not coincide completely due to e.g. errors in the measurements and accumulative layer-peeling algorithm-induced numerical error. Generally, it has been found by the applicant that reconstruction is more accurate closer to the end at which the corresponding measurements were taken. Therefore, in a preferred embodiment a combined reconstruction utilises appropriately chosen weighting functions for the different end reconstructions multiplied by appropriately chosen weighting functions. Alternatively, a half-sum of the different end reconstructions is utilised as the combined reconstruction. As a result, a reconstructed actual design function [qᵣ(z), φᵣ(z)] at numeral 64 is obtained.

In the next step illustrated in FIG. 2D, a compensated design function at numeral 66 is formed based on the initial theoretical design function at numeral 54, and the reconstructed actual design function at numeral 64. The compensated grating design function at numeral 66 in the preferred embodiment is obtained by subtracting deviations between the initial theoretical design function at numeral 54 and the reconstructed actual design function at numeral 64, from the initial theoretical design function at numeral 54. Alternatively, the theoretical design function at numeral 54 is multiplied by the ratio of the theoretical design function at numeral 54 and the reconstructed actual design function at numeral 64. Also, in the preferred embodiments the deviation function is filtered from high frequency components.

Next, the compensated design function at numeral 66 is utilised to write a compensated grating into another optical fibre 68, utilising the same interferometer 58, as illustrated in FIG. 2E.

As illustrated in FIG. 2F, the compensated grating 70 is then measured, in the exemplary embodiment again from both ends utilising the device 62 to determine the experimental transmission characteristics 71 and group delay characteristics (group delay ripple shown at numeral 73) of the compensated grating structure 70 in the optical fibre 68.

The method steps illustrated in FIGS. 2D to 2F may be repeated, with the compensated grating 70 now playing the role of a new test grating until either a desired accuracy is achieved or iterations stop to improve the actual spectral characteristics. In such embodiments, the corrections of all iterations are preferably considered in forming the compensated design function.

It will be appreciated by the person skilled in the art that numerous modification and/or variations may be made to the present invention as shown in the specific embodiments without departing from the spirit or scope of the invention as broadly described. The present embodiments are, therefore, to be considered in all respects to be illustrative and not restrictive.

For example, it will be appreciated that the present invention can be implemented in a manner such that the compensation information gained is repeatedly utilised for a particular writing apparatus, e.g. by storing the compensation information in a processing device associated with the apparatus. In such embodiments, a theoretical design function may be automatically compensated to form the corresponding compensated design functions, either prior to or during the writing of the compensated grating. Thus, each apparatus may only be “mapped” once and the information used repeatedly.

In the claims that follow and in the summary of the invention, except where the context requires otherwise due to express language or necessary implication the word “comprising” is used in the sense of “including”, i.e. the features specified may be associated with further features in various embodiments of the invention.

1. A method of reducing systematic errors in grating writing in an optical waveguide, the method comprising the steps of:
a) numerically designing a theoretical test grating structure for desired spectral characteristics,
b) writing a test grating structure experimentally and according to the theoretical test grating structure design,
c) measuring the actual spectral characteristics of the test grating structure,
d) reconstructing an actual design of the test grating structure from the actual spectral characteristics, and,
e) writing a compensated grating structure using a compensated design based on a comparison of the initial numerical design with the actual design of the test grating.

2. A method as claimed in claim 1, wherein the step of reconstructing the actual design comprises solving an inverse scattering problem based on the measured actual spectral characteristics.

3. A method as claimed in claim 2, wherein the solving of the inverse scattering problem comprises utilising a layer-peeling algorithm.

4. A method as claimed in claim 1, wherein the compensated grating structure is based on a different theoretical grating structure than the theoretical test grating structure.

5. A method as claimed in claim 1, wherein the comparison of the actual with the initial numerical design comprises subtracting the deviations of the actual from the numerical design from the numerical design to form the compensated design.

6. A method as claimed in claim 5, wherein the deviations are filtered from high frequency components.

7. A method as claimed in claim 1, wherein the comparison of the actual with the initial numerical design comprises multiplying the theoretical test grating function with a ratio of the theoretical test grating function and the actual test grating function.

8. A method as claimed in claim 1, wherein the step of measuring the actual spectral characteristics comprises measuring the actual spectral characteristics of the test grating from both ends thereof.

9. A method as claimed in claim 8, wherein the step of reconstructing the actual design comprises utilising different weighting factors for the different end reconstructions of the test grating to form the reconstructed actual design.

10. A method as claimed in claim 8, wherein the step of reconstructing the actual design comprises substantially a half-sum of different end reconstructions of the test grating.

11. A method as claimed in claim 1, wherein the steps c) to e) are repeated, wherein the compensated design structure takes on the role of the test grating structure.

12. A method as claimed in claim 11, wherein the steps c) to e) are repeated until a desired accuracy is achieved or no further improvement in the accuracy is found.

13. A method as claimed in claim 1, wherein the steps of writing the test grating and the compensated grating comprise utilising an interferometer for inducing refractive index changes in the waveguide to form the test and the compensated grating structures.

14. A method as claimed in claim 1, wherein the waveguide is in the form of an optical fibre or a planar waveguide.

15. A method of writing a grating structure in an optical waveguide, the method comprising the step of utilising compensation information gained from conducting the steps of:
a) numerically designing a theoretical grating test structure for desired spectral characteristics,
b) writing a test grating structure experimentally and according to the theoretical test grating structure design,
c) measuring the actual spectral characteristics of the test grating structure,
d) reconstructing an actual design of the test grating structure from the actual spectral characteristics.

16. A method as claimed in claim 15, wherein the compensation information is provided in the form of stored compensation data previously obtained for a particular grating writing arrangement.

17. An arrangement for grating writing in an optical waveguide, the arrangement comprising a processing means arranged, in use, to control the writing of a grating structure based on a theoretical grating design and compensation data obtained for the arrangement to compensate for systematic errors.

18. An arrangement as claimed in claim 17, wherein the compensation data is of a type obtained from conducting the steps of:
a) numerically designing a theoretical grating test structure for desired spectral characteristics,
b) writing a test grating structure experimentally and according to the theoretical test grating structure design,
c) measuring the actual spectral characteristics of the test grating structure,
d) reconstructing an actual design of the test grating structure from the actual spectral characteristics.

19. A waveguide structure incorporating a grating written utilising a method or arrangement as claimed in claim 1.

20. A waveguide structure incorporating a grating written utilising a method or arrangement as claimed in claim 17.
